(19) United States
(12) Patent Application Publication
(10) Pub. No.: US 2008/0280085 A1
(43) Pub. Date: Nov. 13, 2008

(54) Dynamically Tunable Fibrillar Structures

(76) Inventor: Oren Livne, Santa Barbara, CA (US)

Correspondence Address: OREN LIVNE, 115 Danbury Ct., East Windsor, NJ, 08520, US

(21) Appl. No.: 11/767,475

(22) Filed: Jun. 23, 2007

Related U.S. Application Data
(60) Provisional application No. 60/805,745, filed on Jun. 25, 2006.

(51) Int. Cl. B32B 33/00

(52) U.S. Cl. 428/40.1

(57) ABSTRACT

A multi-mode adhesive is disclosed comprising a plurality of fibers connected to a backing material where applying an external influence causes a change in properties of the plurality of fibers or backing. This change in properties causes the multi-mode adhesive to change from one level of adhesive strength to another. The multimode adhesive may be used for a variety of novel applications, from adhesives that can be detached remotely to medical adhesives with adhering and non-adhering modes.

### CROSS REFERENCE TO RELATED APPLICATIONS

This patent application claims priority under 35 U.S.C. Section 119(e) to U.S. Provisional Patent Application No. 60/805,745 filed on Jun. 25, 2006, entitled “Dynamically Tunable Fibrillar Structures” by Oren Livne, which application is incorporated by reference herein.

### BACKGROUND OF THE INVENTION

1. Field of Invention

This invention relates to adhesives, and more specifically, to fibrillar adhesives.

2. Description of Related Art

This application includes reference to numerous publications, which are incorporated by reference herein. Publications are designated with brackets ([0]) where referenced in this specification and are listed in the section entitled References.

Since at least the time of Aristotle, humans have been impressed by the gecko's climbing ability [3]. Geckos are capable of moving rapidly along smooth vertical surfaces and even upside down on ceilings [8,80]. They have even been witnessed falling from trees and catching themselves with a single toe on a leaf [80]. These unique characteristics have been the subject of many studies. Recent work has led to a much more detailed understanding of the mechanism of adhesion, which has enabled the manufacture of a variety of synthetic adhesive structures.

Biological Inspiration—the Gekko gecko

Structure

The Gekko gecko is a pad-bearing lizard that weighs approximately 43.4 gms and has a pad area of 227 mm [2, 50]. Light and electron microscopy studies have elucidated the complex structures that form a gecko toe [83]. The toe has a pad made up of rows of lamellae (400-600 μm in size [47]) that run roughly perpendicular to the gecko's normal direction of motion.

The distal, exposed portion of the lamellae is covered with setae. There are roughly 14,400 setae per mm [2, 85]. In the Gekko gecko, each setae begins at a diameter of roughly 5 microns and then decreases in width at branch points before ending in multiple protrusions, which each terminate with a flattened portion [83]. The seta range in length from 30-130 μm [83].

Each of the seta branches into roughly 100-1000 of the spatula-like structures [8]. The spatula average 200 nm in diameter [83]. Table 1 below details the size characteristics of the gecko and its adhesive foot pad.

TABLE 1
Gecko size characteristics:

| | |
|---|---|
| Setae length (μm) | 30-130 [83] |
| Setae diameter (μm) | 4.7 primary, 2.2 secondary [83] |
| Setae density (setae/mm²) | 14,400 [8, 85] |
| Spatula diameter (nm) | 150 to 280, 200 average [83] |
| Spatula/setae | 100-1000 [8] |
| Setae/gecko | 1 million [83] |
| Spatula/gecko | 1 billion (estimate) |
| Total pad area (mm²) | 227.1 ± 10.81 [50] |
| Gecko body mass (g) | 43.4 ± 1.48 [50] |

The setae are composed of keratin, appear homogeneous and without internal structure [83]. The setae are strongly hydrophobic, as expected from their keratin structure [11].

### Adhesive Strength

Several studies have been conducted to measure the adhesive strength of the gecko's feet. Irschick et al measured the adhesive strength of the front feet of the gecko by placing both front feet on a nearly vertical (85 degree) acetate surface and pulling the lizard down [50]. The geckos produced an adhesive force of 20.04±1.33 N.

Autumn et al measured the adhesive strength of a single gecko toe [11]. The toe measurements were conducted by placing a single gecko toe against a vertical surface and pulling downward until the toe slipped off. For an oxidized silicon surface this yielded a force of 0.218±0.008 N/mm² and for a GaAs surface 0.213±0.007 N/mm².

Individual seta measurements were conducted by Autumn et al [10]. Seta were brought into contact with a silicon cantilever. A small preload was applied perpendicular to the surface to increase contact and induce adhesion. Adding a small parallel pull prior to the perpendicular pull off generated adhesive forces of 13.6±2.6 μN (compared to 0.6±0.7 μN without a parallel component). Parallel pull offs generated adhesive forces of 194±25 μN. In later experiments a single gecko seta on both hydrophobic and hydrophilic surfaces generated roughly 40 μN of adhesive force [11].

Huber et al measured the adhesive force of a single spatulae on a silicon cantilever using an atomic force microscope tip [48]. A preload of 90 nN was ideal and generated the maximum adhesive strength (a more forceful preload provided no extra benefit). Single spatula produced roughly 10 nN of adhesive force. A later Huber et al study showed somewhat similar results with adhesive forces ranging from 7.2-18.4 nN depending on the surface type [47].

The table below summarizes the various measurements.

TABLE 2
adhesive force measurements:

| Front feet - parallel (N) | 20.04 ± 1.33 on acetate [50] |
|---|---|
| Toe - parallel (N/mm²) | 0.218 ± 0.008 on Si |
| | 0.213 ± 0.007 on GaAs [11] |
| Seta - pull off parallel (μN) | 194 ± 25 on Si [10] |
| Seta - pull off perp (μN) | 13.6 ± 2.6 on Si [10] |
| | 41.3 hydrophobic H terminated SiO₂ [11] |
| | 40.4 hydrophilic SiO₂ [11] |
| Spatula - pull off perp (nN) | 10 [48] |

Only a small percentage (0.04%) of a gecko's setae working at maximum capacity are needed to support the animal's weight [8]. This might be construed as overdesign but does have potentially significant uses in nature. As described by Pianka et al, a gecko has been witnessed falling from a tree and catching itself with a single toe on a leaf to prevent capture [80].

The values in Table 2 above illustrate a trend of larger relative adhesive strengths as the size of the measured structure is reduced. This is a good indicator that not all of the seta/spatula are engaged when larger structures like the toe or foot are attached. Calculating the adhesive force (parallel pull off) of the entire animal by extrapolating from the smaller component measurements yields the following:

Front feet=˜20 N or ˜40 N for the entire animal
Toe=0.218 N/mm²×227 mm² of pad area per gecko=˜49 N for entire animal
Seta=194 μN×1 million seta/gecko=˜194 N for entire animal

Acknowledging that these tests are with different substrates, a clear trend of higher forces is apparent when smaller components are measured, indicating that when a larger component, such as a toe or foot, is adhering, a significant fraction of the smaller components are not engaged.

### Attachment

One important common element of the studies described was the need to include a preload prior to perpendicular pull off. According to Autumn et al, a large adhesive force by the setae is contingent upon preload and correct orientation [6, 10]. This is a mechanism similar to what the gecko is seen employing in nature. Both a perpendicular (in) and parallel preload are needed to achieve the best adhesion [10, 47]. In nature, the gecko accomplish this by the “unusually complex behavior of toe uncurling during attachment, which is much like blowing up an inflated party favor.” [10]. Autumn et al noted that the maximum preload possible for a seta was 15 μm, with greater forces causing the seta to buckle.

### Detachment

The multi-leveled structures that make up the gecko toe have evolved to allow the gecko to move quickly along a surface to which it is adhering. This is a very impressive process that involves rapid transitions from toe attachment to detachment. The gecko peels its toes up and away rather than pulling off all at once so detachment is spread over time [8]. According to Autumn et al, this toe peeling is “analogous to removing a piece of tape from a surface.” [10]

Toe peeling may have two key effects:

1. orienting individual seta or putting the seta at a critical angle that helps release, and
2. concentrating force onto a small number of seta at any given time [10].

Autumn et al explored this critical detachment angle (α) and discovered that increasing the angle between shaft and substrate more than 30° degrees (specifically 30.6±1.8° from 10, 25°-35° from 6) causes detachment [6, 10]. The critical angle was determined by maintaining the pull off force constant while gradually increasing the angle until detachment [6].

### Theories for Mechanisms of Adhesion

Over the past century, various theories for how a gecko adheres to a surface have been proposed from secretion of adhesives to suction to electrostatic charges. Many of these theories have been discounted, while others remain the subject of continued debate.

### Discounted Theories

The early secretion theory was quickly overturned as no evidence of glands is seen in the gecko's foot pad [8]. Similarly, the use of suction cups introduced in 1845 by Blackwell [16] with regard to insects was discounted because gecko's feet are able to adhere in a vacuum [8, 23, 80, 83].

In 1904 Schmidt proposed electrostatic attraction as the mechanism of adhesion [8, 80, 83, 86]. Dellit discounted this theory by determining that geckos are still able to adhere in ionized air [8, 23, 80].

In 1941 Mahendra posited that adhesion occurs through actions like spikes of a climber boot [72] This theory was rejected by Ruibal et al [83] in 1965 who asserted the friction mechanism, which had also been proposed by Hora [46] in 1923. According to Ruibal, the spatula structures at the end of the setae clearly indicate that the spike mechanism is not in effect, rather adhesion appears to be a friction-based phenomenon [83]. According to Dellit in 1935, the setae act like hooks, interlocking with surface irregularities [23].

The friction and interlocking mechanism have been investigated by looking at adhesion on both rough and smooth surfaces. If either mechanism were in effect, adhesion on rough surfaces would likely be greater than adhesion on very smooth surfaces, and that has not been the case [8]. In addition, geckos are able to climb upside down. Typically friction is seen to operate against the direction of motion and would not have a vertical component [8]. Microlocking might be a secondary effect, but adhesion occurred even on molecularly smooth SiO₂ [8]. An alternative force or forces must therefore be contributing to adhesion.

### Current Theories

Haase, in 1900, made an early indication that geckos adhere by intermolecular forces [41, 8]. Hiller later suggested that substrate properties rather than texture caused adhesion [8, 45]. Both of these early hypotheses are in agreement with one of the well supported current theories—that van der Waals (VDW) interactions provide the force behind the geckos' adhesion. There is continuing debate regarding whether or not capillary forces also contribute to the adhesive force.

### VDW

The VDW force is a type of weak intermolecular force composed of three components:
1) orientation or Keesom interaction—angle-averaged interaction between permanent dipoles (two polar molecules);
2) induction or Debye interaction—angle-averaged interaction between polar molecule and non-polar molecule (dipole—induced dipole);
3) dispersion or London forces (induced dipole—induced dipole) [51].

The dispersion forces are always present while the first two interactions depend on the nature of the material [51]. These three forces each vary with the inverse sixth power of distance when looking at interatomic pair potentials. As detailed by Israelachvili [51], these pair potentials can be summed to yield:

W=−A/12πD²
where W is the interaction free energy,
A is the Hamaker constant, and
D is the distance between the surfaces

The Hamaker constant, A, of most condensed (liquid, solid) phases is between 0.4×10⁻¹⁹ to 4×10⁻¹⁹ J, the higher end of the spectrum for metals and metal oxides when compared to non-conducting materials [51]. The Hamaker constant varies with polarizability [51]. Retardation effects can also reduce the effective value of the Hamaker constant as separation distances increase (roughly, beyond 5 nm).

In 1968, Hiller noted that geckos cannot adhere to weakly polarizable Polytetrafluoroethylene (PTFE), lending support to the VDW theory [8, 45]. In 2002, Autumn et al provided substantial additional support for the VDW theory [11]. Highly hydrophobic toes of geckos adhered to both hydrophobic and hydrophilic surfaces, supporting the VDW effect over a capillary effect. If a capillary effect were significant, the adhesive force would be expected to vary with hydrophobicity, which they did not [11]. With VDW adhesion, size and shape rather than chemistry are expected to be the dominant factors in adhesive strength [11].

Autumn et al did acknowledge a potential issue—there was no difference in adhesion based on polarizability of the surface. Both highly polarizable GaAs (∈=10.88) and Si (∈=11.8) surfaces had adhesion equivalent to moderately polarizable SiO₂ (∈>4.5), where ∈ is the dielectric constant [111]. Autumn et al explain that the bulk (66%) of the change in adhesive strength is expected to occur over the range 1<∈8<5 [11]. Above this range significant changes are not expected. It would be interesting to compare various surfaces with polarizabilities in this range.

Bergmann et al, provide evidence that adhesion is not mechanical and put their support behind a VDW mechanism [15]. The impact of temperature was evaluated and adhesion was found to be temperature independent [15]. If a muscular component was involved, the adhesion would be expected to improve as the lizards warmed up (but not too hot) [15]. Bergmann et al state that their findings support a passive process, specifically a VDW mechanism.

### Capillary

Various groups have presented conflicting evidence regarding the capillary effect and it remains plausible that water does in some way impact the strength of adhesion. Huber et al performed a series of experiments under varying humidity. Increasing humidity was found to contribute significantly to gecko adhesion [47]. Substrates of different hydrophilicity (as indicated by contact angles) were also tested and an increase in adhesion with hydrophilicity was demonstrated [47]. These results suggest that a water layer between spatula and substrate impacts adhesive force [47]. Huber et al note that “real” capillary condensation only expected at very high humidity (90%) so the effect may be one of an adsorbed monolayer of water, which effectively increases the Hamaker constant.

Sun et al also found a similar effect [95]. Single spatula forces were measured under varying humidity levels and water was found to strongly affect the adhesion force [95]. Sun et al believe the dominant force involved is capillary and note that relative humidity in the natural environment is always at least 10%, so a capillary force role is possible [95]. Using simulated forces in a sphere/plane model, Sun et al found capillary forces dominate at relative humidity (RH)>16% [95]. Measurements were taken at varying RH and the same trend as through calculations was confirmed. Increasing RH led to increasing adhesive force supporting the contention that capillary forces dominate [95]. Sun et al also note that the VDW force should show the opposite effect and increase in a lower RH environment since there is less water screening further supporting the assertion that VDW is not the main mechanism [95].

Autumn et al generally oppose the capillary effect [8]. The principle force in many insects, frogs, and mammals is capillary, but in those cases the animals have glands in their feet [8]. The gecko does not. In addition, water viscosity is not high, so the capillary force is expected to be strong in the normal direction and weak in shear, the opposite of empirical data for the seta [8]. Autumn et al also note that geckos are found in all humidity levels without any clearly visible effects on adhesion [8]. If capillary forces were in effect, humidity might impact adhesion in nature [8]. If humidity is too high or too low, capillary forces tend to decrease [8, 51].

Geim et al support the theory that both capillary and VDW forces are involved [38]. It may be the case that Huber et al are correct and a water monolayer provides added adhesive strength [47]. Even under virtually pure nitrogen (1.5% humidity, the hygrometer detection limit) an adhesive force was generated so capillary is unlikely to be the sole effect [47].

### Modeling

A number of groups have developed models of the gecko adhesive structures in order to better understand how the complex hierarchical structures lead to such significant adhesion. Many of the models are based on the work of Johnson et al (the JKR model) [57].

The model of Jagota et al identifies uniform and intimate contact between adhesive and substrate as a key requirement for significant adhesion [55]. For non-fibrillar adhesives, a softer material permits greater contact with a substrate but also causes greater adhesion to particulates [55]. A fiber structure provides a unique alternative. In compression each fiber buckles easily, transferring load to other fibers [55]. This generates more uniform contact without requiring softer materials [55]. An array of stiff fibers is able to act like a plastic material, yielding under constant stress under compression [55]. In addition to avoiding adhering to particulates, such an array avoids the problem of trapped air bubbles.

Arzt et al point out that in nature, heavier animals tend to exhibit finer adhesion structures [4]. The adhesion force is proportional to the linear dimension of contact so splitting one contact into four yields twice the adhesive force [4]. Shah et al outline several important performance parameters for gecko-like adhesives:[88]
“Attachment and detachment forces
Rough surface adaptation
Self-cleaning property
Durability”
   To achieve the associated desired properties, there are several design variables to control:
“Fiber density
Fiber orientation
Fiber material elastic modulus and surface energy
Fiber geometry (length, diameter, aspect ratio and tip shape)”

The gecko adhesive has multiple layers of compliance and Shah et al model three based on VDW forces: Lamellae, Micro fibers, and Nanofibers. These three structural levels can be used to address surface roughness on three size scales:[88]
Macro—soft foot tissue
Micro—micro fibers (setae)
Nano—nanofibers

FIG. 1 illustrates a design with three levels of compliance. Nanofibers 20 are connected to micro fibers 30, which are connected to a macro level material. The nanofibers 20 can be used to adhere to a substrate 10. FIG. 2 shows the adhesive being removed from a surface, with the rightmost fibers detaching before the leftmost because the adhesive is being peeled off from right to left.

Shah et al acknowledge clumping as a potential problem. If fibers are too close or dense then they might attract and stick. From a modeling standpoint, to avoid clumping, the spring force of the fibers must exceed the adhesion force between the fibers to avoid sticking [88].

The Shah et al model predicts an adhesion peak with fibers of radius 100 nm for keratin [88]. Thin fibers <100 nm can be packed together more closely than thick fibers (if the thin fibers have high elastic modulus) [88]. However, as the fibers thin, the VDW force per fiber is reduced [88]. Balancing these two factors yields the maximum at radius equal to 100 nm. Shah et al also identify preloading as needed for good contact and adhesion.

The Gao et al model indicates that ideal fibers will be of roughly the same size as proposed by Shah et al. According to Gao et al, optimal adhesion that is robust and shape insensitive occurs when fibers are reduced to diameters on the order of 100 nm [35]. When removing the adhesive, stress concentration is expected to occur at the edges of fiber contact, increasing the stress causes a crack to form between the fiber and substrate that propagates along the contact point [35]. The ideal shape of the fiber would have a uniform separation between the surfaces at the time of pull of [35]. While this is theoretically possible, it is not realizable at the macro scale [35]. Fortunately, as the fiber size is reduced, its shape becomes less important [35]. Gao et al also illustrate that, if the surface is elastic, it will deform as the fiber approaches (the fiber may deform as well) [35]. The optimal fiber tip shape will therefore not be flat but will be concave since the surface is likely to go slightly convex upon fiber approach [35].

Gao et al modeled fiber approach and withdrawal from a surface for fibers of three different sizes and found substantially different results for each [35]. For small fibers, approach and withdrawal follow the same path and the adhesive force is always attractive [35]. For larger fibers, the adhesive force positive but unstable upon approach. Fibers jump forward after reaching a certain distance [35]. Withdrawal follows a different path, the adhesive force increases then drops off rapidly [35]. Even larger fibers exhibit two equilibrium positions with the adhesive force negative between the two [35]. It is necessary to press hard against the substrate to generate significant adhesion before withdrawal [35]. The cut off for fibers to spontaneously attract without this hard push is estimated at a radius of 282.5 nm. Smaller fibers can spontaneously form complete contact.

Using the JKR model applied to a cylindrical stalk with frictionless contact to a rigid substrate, Gao et al demonstrate that a flat punch is the optimal shape because there is no stress concentration [36]. If there are no defects on the surface, the adhesive strength would be equal to VDW theoretical max [36]. This would be regardless of the size of contact, however, any surface irregularities or other defects would induce stress and cause adhesion failure [36].

Under certain conditions in the Gao et al model of the spatula as a square cantilever, the VDW interaction may cause clustering [36]. A hemispherical tip required a huge (not practically attainable) Young's modulus to meet the stability conditions. A flat tip is therefore needed for the stability necessary to avoid clustering [36].

Gao et al investigated the hierarchical structure by modeling a single seta with a cohesive layer of spatula over the tip surface [36]. The interaction energy was modeled as a combination of VDW and spatula elasticity [36]. Two mechanisms of adhesive failure were possible—detachment or sliding. At angles greater than 30° detachment was the dominant mechanism [36], consistent with the experimental determination of the critical angle by Autumn et al [6]. The dramatic order of magnitude change in adhesive force as the angle is increased from 30° to 90° enables rapid attachment and detachment [36].

In a later investigation, Gao et al used a fractal model of gecko hairs to demonstrate the key role of hierarchical levels in robust adhesion [106]. The work of adhesion can be exponentially enhanced with each added level of hierarchy. Barring fiber fracture, can generate flaw tolerant adhesion at any length scale [106].

Crosby et al introduce models for tuning adhesion strength using patterned substrates. By varying the geometry of the patterns, adhesive strength can be varied. These are non-gecko-like structures but can be considered when evaluating how to tune fibrillar adhesives.

Crosby et al investigated low aspect ratio pillars or pancakes to see impact of different designs on adhesion [21]. By varying the pattern designs they were able to yield different adhesive strengths. Thomas et al then investigated patterned holes and describe how patterns of circular surface holes can alter adhesion. They determined that the contact edge, not area, is of key importance [98].

### Synthetics

With the natural gecko structure as inspiration and the various models as guidance, several groups have developed synthetic fibrillar adhesives. These nano-fiber structures fall into three main categories:

1) Polymer

2) Nanotube

3) Nanofiber

### Polymer

The polymer fibers are made using a variety of techniques including:

1) Molding

2) self assembly

3) lithography/etching

4) e-field

Autumn et al manufactured polymer fibers using a molding method [11]. Two types of hydrophobic polymers were used: a) silicone rubber and b) polyester resin. An atomic force microscope (AFM) probe with a conical tip of apex radius (10-20 nm) and 15 μm height was impressed into wax to create multiple indentations. The surface was filled with polymer, which was allowed to cure and then was peeled off the wax. This resulted in fibers with dimensions similar to the natural 0.2 μm spatula.

Results indicate synthetics will not need to be as complex as the natural structures [11]. Silicone rubber fibers with 0.23-0.44 μm tip radius had an adhesive force of 181 nN upon perpendicular pull off for spatulae. Polyester fibers with 0.35 μm tip radius had an adhesive force of 294 nN [11].

Geim et al 2003 fabricated hairs by etching a polyimide film using a patterned aluminum mask [38]. Geim et al also emphasize the importance of hierarchical compliance. Hairs need to be flexible and need to be on a flexible substrate so that the tips of individual fibers can act together and attach to an uneven surfaces at the same time [38].

Arrays of hairs of diameter from 0.2 to 0.4 μm and height 0.15 to 2 μm, with periodicity 0.4 to 4.5 μm were tested [38]. The perpendicular force to detach the fibers from an SiO₂ surface was measured using AFM. Adhesion was shown to depend strongly on preload [38]. With the Geim et al experimental apparatus, the maximum preload possible was 10 mg, which was considered insufficient for optimum contact [38]. The maximum adhesive force reached only 10 μN for the densest array of hairs, which led Geim et al to believe not enough hairs were making contact [38].

The adhesive force generated was proportional to the density of hairs, but depended only weakly on diameter and height [38]. Geim et al speculate that pillars make point-like contact and do not connect over the entire top surface of the pillar. In macroscopic tests, use of a soft rather than solid base yielded dramatically improved adhesive properties [38]. Force varied linearly with contact area and was essentially independent of preload [38]. Geim et al assume all hairs in the macro structures with a soft base are able to contact the surface [38]. The force per hair was approximately 70 nN and a 1 cm patch was able to support 3 N [38]. The patch was able to go through several attachment/detachment cycles before degradation [38].

Geim et al suggest that, for optimal adhesion, getting the maximum number of hairs contacting the surface is of key importance, while hair geometry is less critical [38]. Hair density must also be carefully considered to avoid clumping [38]. Hairs must be flexible enough to attach to uneven surfaces but should not curl, tangle, or break [38]. Thin pillars tend to fall and closely spaced fibers tend to bunch [38]. Geim et al propose that durability would be better using flexible hydrophobic materials (such as keratin, which is used in nature by the gecko) that would not stick to each other or the base, allowing for denser arrays [38].

Sitti et al have developed several procedures for making gecko-like adhesives: [75, 76, 90, 91]

### 1) Molding:

Liquid polymer and a template were used to create micro and nanohairs. The templates used were commercially available nano and micro pore membranes, custom made silicon molds, or AFM nano-probe indentations in wax.

The commercially available membranes used have pore size from 0.02-20 μm, thickness of 5 μm, density 10⁵ to 10⁸ pores per cm [2, 76]. To retrieve the cured polymer, it was either peeled off or the membrane was etched away. 200 nm diameter, high aspect ratio fibers were produced but clumping was significant [76]. As length increases, the inter-fiber adhesion force exceeds the spring force, and clumping results [76]. An additional level of hierarchy can be provided by using two membranes, one micro-pore and one nano-pore, that are bound together [90].

To avoid clumping, silicon wafers were patterned through photolithography and deep reactive ion etching to create a negative mold of controlled size characteristics [76]. The fibers can be made with an angle to the surface to enable a low preload.

Another alternative provided was the use of AFM (20-30 nm tip) or S™ (30-40 nm tip) nano-probes pushed into a wax surface [90]. This was used to make silicone rubber nanopyramids −10 μm by 20 μm bumps (for S™) [90].

### 2) Self Assembly:

A thin, liquid-polymer film was coated on a conductive surface. A parallel plate was then used to apply an electric field. Pillars grow from the unstable film until they touch the plate and growth is stopped (using precise optical microscope feedback) [90]. The fibers can then be sheared and baked into place to provide a desired angle relative to the surface.

Northern et al have developed a hierarchical dry adhesive structure using MEMS techniques [78, 79]. Their adhesive structure provides three levels of compliance:

1) nanorods
2) platform fingers
3) pillar

MEMS processing technology is used to make 20-150 μm platforms supported by pillars and coated with 2 μm long 50-200 nm diameter polymer nanorods. In prior work, individual fibers/rods showed expected adhesion, but arrays did not unless a “compliant backing” was used, indicating the structures need multiscale compliance [78, 79]. Prior work also demonstrated that adhesion was reduced due to bunching and contamination (likely the basis for the very hydrophobic gecko toe pad) [78, 79].

Northern et al targeted their design towards chip integration [78, 79]. They used an electric field to grow nanorods from photoresist off a silicon dioxide platform [78, 79]. The photoresist is made hydrophobic by placing it in a CF₄ plasma, which gives a fluorocarbon coating and increases the fiber diameter to roughly 350 nm [78, 79]. The hydrophobic coating increased adhesion despite a decrease in surface energy [78, 79] (maybe due to diameter increase or possibly, reduced clumping). The resulting adhesive force increased with applied normal load (preload)—likely due to an increase in contact area [78, 79]. Adhesion was estimated to be one order of magnitude worse than the gecko [78, 79].

### Carbon Nanotubes

Yurdumakan et al were able to demonstrate strong adhesion forces two hundred times higher than observed for the gecko when looking at nanometer level [109]. The structure was based on multiwalled carbon nanotubes embedded in a polymer surface. Carbon tubes were grown on silicon or quartz (diameter 10-20 nm, length 65 μm), then embedded in PMMA matrix [109]. The PMMA plus carbon nanotubes were peeled off the substrate. The previously silicon-facing side was then etched to reveal 25 μm of the nanotubes [109]. The nanotubes were mostly vertical and formed tangled bundles of roughly 50 nm in diameter, yielding a rough surface that enhanced adhesion [109].

Adhesive force was measured with an SPM. The calculated pull off force/area was 1.6×10⁻² nN/nm², much greater than a gecko's setae which has a pull off force on the order of 10⁻⁴ nN/nm² [109]. Yurdumaken et al hypothesize that the added strength comes from a combination of VDW forces and energy dissipation due to nanotube elongation [109]. The VDW force is generated from surface contact with multiple nanotubes or a single tube with a large area of contact [109]. The energy dissipation stems from the nanotube's high strength and high flexibility under large strain [109].

Zhao et al note that the high adhesive strength demonstrated by Yurdumaken et al may be significantly enhanced by side contact, which would not be present in a macroscopic (and therefore non-ideal) environment [110]. Zhao et al also used multiwalled carbon nanotube (MWCNT) arrays to mimic the gecko adhesive structures. They were able to demonstrate 11.7 N/cm² (1.17×10⁻⁴ nN/nm²) with a normal pull and 7.8 N/cm² (0.78×10⁻⁴ nN/nm²) in shear [110]. This value is comparable to a gecko foot at 10 N/cm² (10⁻⁴ nN/nm²) [110]. It is curious that the sheer force is less than normal. Others have seen opposite

Zhao et al identify certain difficulty with the design of their MWCNT adhesive. A large preload is needed and there is no way to detach easily (the macro structure is too stiff to peel) [110]. The MWCNT are electrically and thermally conducting, which may prove beneficial for certain applications [110].

### Nanofiber

Dubrow describes a fibrillar adhesive composed of silicon nanofibers roughly 40 nm in diameter and 50 μm long, made using CVD on a silicon substrate [25]. The resulting fiber density was 2 nanofibers/μm [2, 25] A 200 g weight was suspended by a 2 cm×1 cm piece of adhesive pressed against a glass microscope slide [25]. The adhesive functioned on a variety of substances, including glass, stainless steel, Formica, and painted metal, but not on Teflon [25]. The adhesive was tested as an enhanced gripper for a medical clamp used on a pig aorta [25]. The force required to generate slippage increased from 4 lbs to 7 lbs [25].

The Dubrow patent application suggests a large number of potential materials for the nanofibers (nanofibers, nanotubes, nanowires, or nanowhiskers) including: silicon, glass, quartz, plastic, metal, polymers, carbon, carbon nanotubes, TiO, ZnO, ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, GaN, GaP, GaAs, GaSb, InN, InP, InAs, InSb, PbS, PbSe, PbTe, AIS, AlP, AlSb, SiO1, SiO2, silicon carbide, silicon nitride, polyacrylonitrile (PAN), polyetherketone, polyimide, an aromatic polymer, or an aliphatic polymer [25]. Potentially, the fibers could also be biological in nature, such as protein, carbohydrate, lipid, or various combinations of the above.

The choice of materials can be based on the conditions of use, which may include temperature, pH, the presence of light/UV, the ambient atmosphere, the strength and direction of the forces to be applied, the durability of the surface, and the setting (eg medical) [25]. For example, ZnO wires could be more brittle than silicon/glass, while carbon may have higher tensile strength [25].

The nanofibers can be the same material as the backing and/or substrate to which they are attached or a different material [25]. The nanofibers can be curled or curved and can potentially touch at the side rather than the tip [25]. The nanofibers do not require enlargements at their ends like the spatulae of geckos[25].

The nanofibers can be grown on such rigid surfaces such as silicon [25]. They can then be transferred to a flexible backing such as rubber [25]. Alternatively, the nanofibers can be grown on flexible foils such as aluminum [25]. For high temperature growth, any metal, ceramic or other thermally stable material can be used as a substrate [25]. Low temperature synthesis methods, such as solution phase, can be used with flexible polymer substrates for nanofiber growth [25].

The nanofibers allow significant contact between surfaces because the individual fibers are rigid enough to extend from one surface to the other and compliant enough to bend to compensate for surface irregularities [25]. This increase in area of contact can lead to increased VDW forces and/or increased friction [25].

Yoon et al describe a capillary directed process for fabrication of nanostructures [107]. The process allows fabrication of structures with different aspect ratios and tip shapes by capillary draw of polymer into the voids of a mold.

### Functionality

The Dubrow patent application details the option of having fibers that are coated or functionalized to enhance an existing property or to add new properties [25]. For example, polymers, ceramics, or small molecules can be used as coating materials for the nanofibers [25]. These new or enhanced properties can include: water resistance, improved mechanical or electrical properties, higher VDW forces and/or friction forces, and anti-bacterial activity [25].

Fibers can also be functionalized by adding one or more functional groups (for example, a chemically reactive group) [25]. These groups can: [25].
chemically interact with the surface, either through VDW forces, friction, or by binding covalently with a chemical group on that surface,
increase the dielectric constant of the nanofiber, which increases the VDW attraction between the nanofiber and the surface to which it is contacted,
decrease the VDW attraction between the nanofiber and the surface (e.g., in uses which require a weaker adherence than would otherwise result without the group).
increase or decrease friction forces between the nanofibers and opposing surfaces.

In addition, the group attached/associated with the nanofibers can be specific for another groupy on a surface (e.g., streptavidin on either the nanofiber or the surface to be contacted/matched up with biotin on the other surface or an epoxy group matched up with an amine group on the other surface, etc.). Those of skill in the art will be familiar with numerous similar pairings which are optionally used herein (e.g., amines and boron complexes, etc.).”

### SUMMARY OF THE INVENTION

Novel mechanisms for dynamically adjusting or tuning the adhesive strength (as well as other properties) of materials, inspired from the adhesive structures of the Tokay gecko or Gekko gecko, are presented. The methods of dynamically tuning adhesive strength enable a variety of novel applications, from adhesives that can be detached remotely to medical adhesives with adhering and non-adhering modes.

### BRIEF DESCRIPTION OF DRAWINGS

FIG. 1—three level compliant structure

FIG. 2—three level compliant structure removed from surface

FIG. 3—fibers protruding from a substrate

FIG. 4—the fibers of FIG. 3 collapsed so tips contact substrate/backing

FIG. 5—the fibers of FIG. 3 clumped together

FIG. 6—fibers of different types in two states, clumping and erect

FIG. 7—the fibers of FIG. 6 in three states, collapsed, clumping, and erect

FIG. 8—Fibers protruding from a substrate

FIG. 9—The fibers of FIG. 8 with increased diameter

FIG. 10—The fibers of FIG. 8 with increased length

FIG. 11—fibers adjacent to a rough surface

FIG. 12—non-compliant fibers contacting a rough surface

FIG. 13—compliant fibers contacting a rough surface

FIG. 14—compliant fibers on a non-compliant backing contacting a very rough surface

FIG. 15—compliant fibers on a compliant backing contacting a very rough surface

FIG. 16—fibers protruding from a substrate

FIG. 17—deflected fibers

FIG. 18—deflected and non-deflected fibers

FIG. 19—fibers of three different densities protruding from a substrate

FIG. 20—the fibers of FIG. 19 with the densest fibers clumped

FIG. 21—the fibers of FIG. 19 with the densest and second most dense fibers clumped

FIG. 22—the fibers of FIG. 19 with the clumped at all densities

FIG. 23—fibers with functionalized tips protruding from a substrate

FIG. 24—the fibers of FIG. 23 pulled towards the substrate

FIG. 25—fibers protruding from a substrate

FIG. 26—fibers protruding from a substrate with a shrunken midsection

FIG. 27—the fibers of FIG. 26 collapsed at the shrunken midsection

FIG. 28—fibers protruding from a substrate with a midsection shrunken on one side

FIG. 29—the fibers of FIG. 28 collapsed at the shrunken midsection

FIG. 30—rigid tall fibers and regular fibers protruding from a substrate

FIG. 31—the fibers of FIG. 30 with the tall fibers deflected

FIG. 32—the fibers of FIG. 30 with the tall fibers deflected and the regular fibers contacting a surface

FIG. 33—a hook and loop fastener with opened loops

FIG. 34—an unconnected hook and loop fastener

FIG. 35—a connected hook and loop fastener

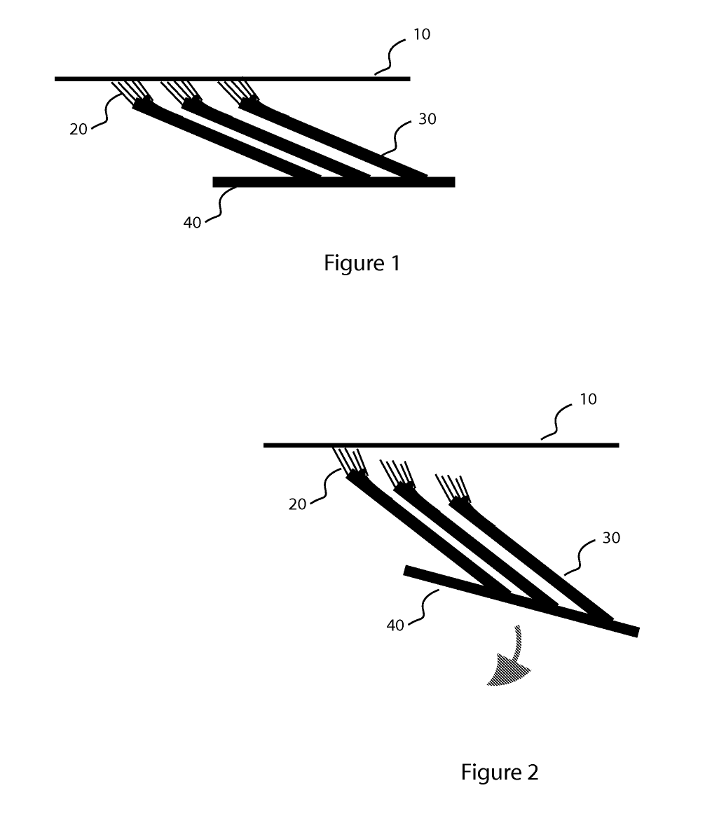

### DETAILED DESCRIPTION OF THE INVENTION FACTORS AFFECTING ADHESIVE STRENGTH AND FACILITATING ATTACHMENT AND DETACHMENT

Investigations of the gecko's toe pads, the models, and the development of synthetic structures have illustrated a number of factors affecting the strength (as well as the ability to induce attachment and detachment) of the fibrillar adhesive. The main influence appears to be structural or geometric but material properties can also play an important role.

The structural properties include: [88]
Fiber Geometry
   Length
   Diameter
   Aspect ratio
   Tip shape
Fiber density
Fiber orientation

For multilevel structures, these properties can occur on both the micro (seta) and nano (spatula) scale. The results of Autumn et al indicate that synthetics can be simpler than the natural gecko structures and have only two levels of hierarchy and still yield an adhesive effect [11].

### Fiber Geometry

Researchers have been fairly consistent in their model evaluations of optimal fiber diameters. Shah et al predict adhesion peak with fibers of radius 100 nm for keratin [88]. The Gao et al model indicates that shape insensitive optimal adhesion occurs when fiber diameter is reduced to lengths on the order of 100 nm [35]. In nature, the gecko's spatula averages 200 nm in diameter [83]. Gao et al also indicate that “The smaller the size, the less important the shape.” [35]. However, very thin fibers tend to fall [38].

The optimal tip shape will likely vary based on the specific surface geometry. According to Gao et al, the ideal shape would have uniform separation between surfaces at the time of pull of, however this is likely not realizable on a macro scale due to variations in surface and fiber shape [35]. Autumn et al note that a change in the geometry of the spatulae may facilitate detachment [6].

### Fiber Density

Geim et al suggest that for optimal adhesion, the limitations of hair density need to be considered [38]. Thin fibers tend to fall and closely spaced tend to bunch [35]. Geim et al propose that using flexible hydrophobic materials (such as keratin of gecko) would make fibers less like to stick to each other and to the base on which they are attached, allowing for denser arrays [35].

### Fiber Orientation

Seta oriented with spatula towards the surface had significantly higher adhesion than with spatula oriented away [10]. Correct orientation enables easier attachment and detachment [6, 10]. By angling the seta to the surface the required preload is reduced [91]. Increasing the angle between the seta shaft and the substrate more than 30° causes detachment [6, 10]. Autumn et al note that a change in the orientation of the setae may facilitate detachment [6].

The following material properties also impact the adhesive strength and ease of attachment and detachment:
Multilevel Compliance
   Fiber rigidity/elastic modulus (also a function of diameter/length, aspect ratio)
   Backing rigidity
Polarizability
Surface Energy

### Multilevel Compliance

The gecko has at least three levels of hierarchical structures involved in adhesion but synthetics with two levels of hierarchy also appear to yield an adhesive effect [11]. While individual fibers demonstrate expected levels of adhesion, arrays do not unless put on a compliant backing [79]. Both backing and fiber need to be compliant to demonstrate optimal results. Fibers need to be flexible and need to be on flexible substrate so that the tips of individual fibers can act together and attach to uneven surfaces at the same time [38]. Fibers should be flexible enough to attach to uneven surfaces but should not curl, tangle or break [38].

### Polarizability

The strength of VDW interactions varies with the Hamaker constant, which, despite its identification as a constant, varies with polarizability [51]. The Hamaker constant of most condensed (liquid and solid) phases is between 0.4×10⁻¹⁹ to 4×10⁻¹⁹. Metals can have several times higher Hamaker constants than polymers. A change in polarizability has the potential to change the adhesive force generated.

### Surface Energy

The surface energy of the fiber materials used, as measured by water contact angle, has demonstrated some effects on adhesive strength.

The geometric and material properties both impact the formation of another significant influencer of adhesive strength:

### Clumping

Clumping is a significant potential problem with synthetic fibrillar adhesives. If fibers are too close or dense they might attract and stick to one another, impacting the adhesive strength [88]. From a modeling standpoint, the fiber spring force must exceed the adhesion force between the fibers to avoid sticking [36]. Otherwise, the same VDW interaction that causes adhesion to a surface may also cause the fibers to adhere to one another. As the fiber length increases the inter-fiber adhesion force can become greater than the spring force [76]. Thin pillars tend to fall and closely spaced tend to bunch [38].

The gecko uses very hydrophobic fibers to prevent adhesion reduction due to bunching (and contamination) [78, 79]. Jakota et al suggest that to minimize clumping it may be necessary to differentiate properties such as stiffness and surface energy at the fibril ends vs sides [55].

The interaction of the fibrillar material with a surface provides another key determinant of adhesive strength:

### Contact Area

The number of fibers contacting a surface and the total contact area have a clear impact on adhesive strength. The more fibers contacting the surface, the greater the force [38]. Preloading is believed to be used to get more fibers in proximity to the surface to allow VDW (or other) forces to take over [88].

### Mechanisms for Dynamically Changing Adhesive Properties and Facilitating Attachment and Detachment

The various factors affecting adhesive strength can be influenced by external forces/conditions to yield a change in the adhesive strength or to facilitate attachment or detachment. Adhesion can be turned completely on or completely off or varied between these levels. An attached adhesive can be detached by varying one or more of these factors. The external influences that can be used include, but are not limited to:
Thermal
Electric
Magnetic
Photonic
Chemical/Solution properties
Mechanical

Lahann et al discuss various material concepts for smart dynamically controllable surfaces [62]. Most of the examples require solution-based systems and all are on molecular scale (1-2 orders of magnitude less than gecko-like fiber structures). While none of these address adhesion, they do provide several illustrative methods for changing surface conditions using the influences listed above. These can be extended to fibrillar adhesives as detailed below. The examples include:

1) Electrochemical approaches
Electrochemical reaction alters the physico-chemical properties of the surface. An electrical potential is applied to change the wetability/hydrophobicity of a surface.
2) Photoinduced switching
Light induces a change in surface properties.
Chemical system changes wetability upon application of light.

### 3) Temperature and pH Control.

Polymer/polypeptide reorient when solvents change.
Temperature change induces change in polymer phase, altering tackiness.
Switch from cationic to anionic when change pH
4) Mechanically controlled switching
5) Electrically driven conformational switching
An electric potential is used to cause a conformational change.
The various external influences discussed above have been detailed by a number of groups. The influencers can be employed as discussed below to cause a change in adhesive properties and facilitate attachment and detachment.

### Thermal

A thermal influence has the capacity to change a fibrillar adhesive in several ways. This includes, but is not limited to, changing rigidity, size, and shape of the fibers leading to a change in adhesive properties.

Crevoisier et al describe how a small temperature change causes a polymer to alter phase and go from rigid to soft [20]. A structured polymer film that is mesoscopically ordered (10 nm scale) at room temperature changes to disordered with a slight temperature increase.

In a fibrillar adhesive, the use of a polymer capable of transitioning from rigid to soft with a change in temperature will influence several of the factors affecting adhesive strength. Using such a polymer in place of those described in the Synthetics section will enable properties to be dynamically tuned by changing temperature.

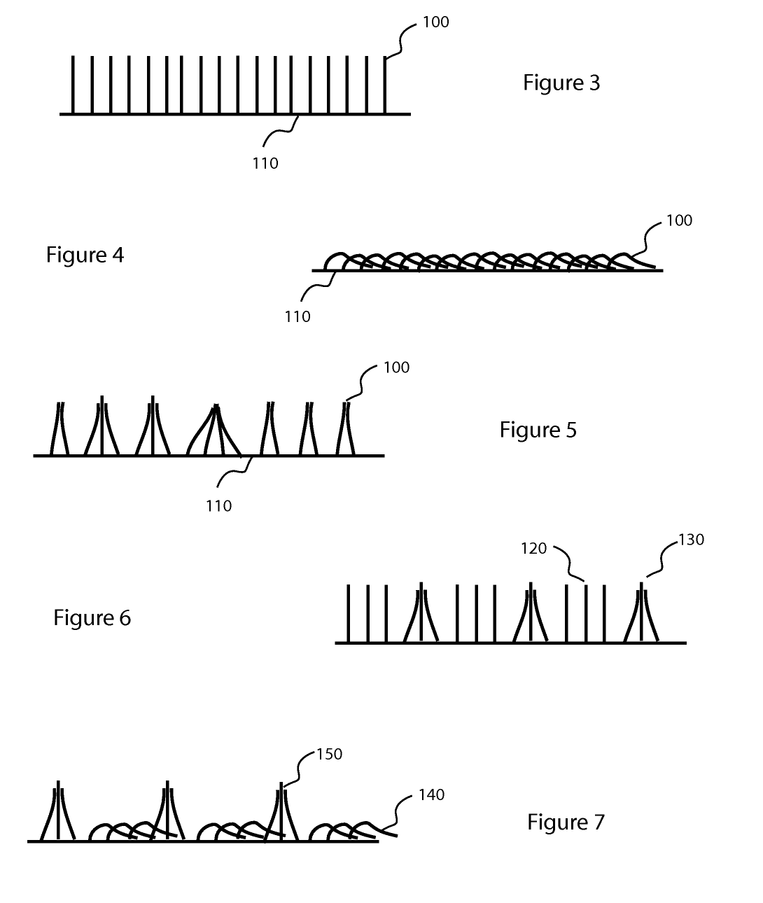

For example, the relatively rigid fibers 100 illustrated in FIG. 3, which are attached to a substrate 110 could transition to softer fibers upon an increase in temperature. With a significant increase in softness or flexibility, such a transition could cause the fibers to collapse towards the substrate as illustrated in FIG. 4. This would cause a change in the section of the fiber exposed and accordingly would change the adhesive properties of the material. If the increase in softness were not as large, the fibers' spring force could reduce slightly causing the fibers to clump as illustrated in FIG. 5. Such clumping would also cause a change in adhesive characteristics.

By using fibers of different composition, a combination of effects could occur such that some of the fibers 130 first clump as illustrated in FIG. 6 upon a slight increase in temperature, while other fibers 120 remain sufficiently rigid to continue to remain upright. Upon further increase, some of the fibers 140 would collapse to the surface and others would clump 150 as illustrated in FIG. 7. Upon even greater increase all of the fibers could collapse to a state similar to that in FIG. 4. Increasing the temperature of such an adhesive would gradually change the adhesive strength. The different compositions could be polymers of different phase-transition temperatures or other differing characteristics such that a temperature change would alter their rigidity at different temperatures.

An alternative temperature changing effect is described by Takei et al [96]. A material that exhibits a large swelling change in aqueous media, with a small temperature change is described.

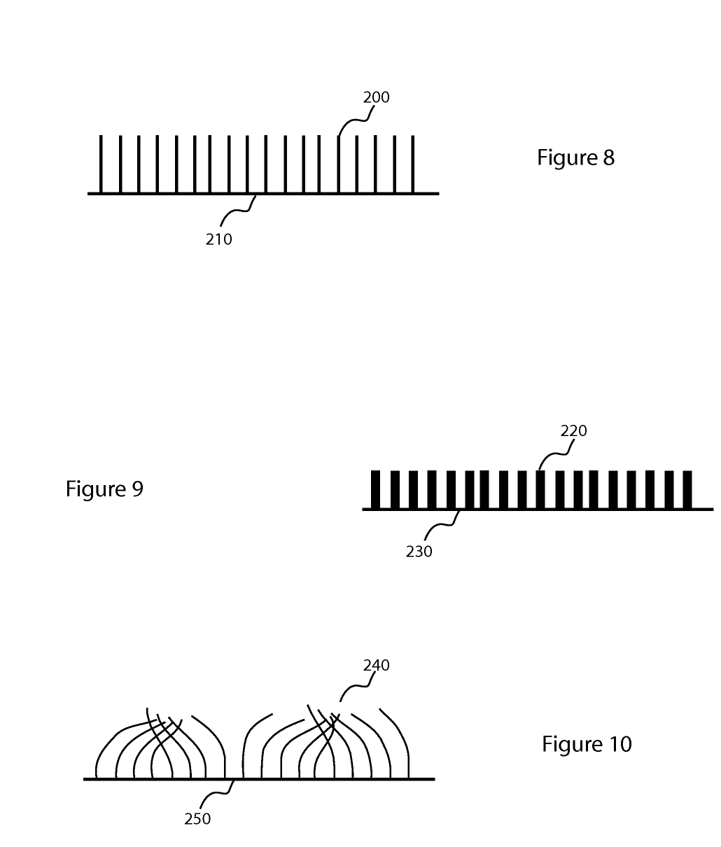

Using such a material, or others which demonstrate a similar effect, in a fibrillar adhesive will influence several of the factors affecting adhesive strength. The fibers 200 of FIG. 8 would swell as illustrated in FIG. 9 causing an increase in fiber diameter. Such an increase in diameter would increase the fiber tip size and therefore potentially the surface contact area. Increasing the diameter would also increase the extent of clumping. Therefore, increasing the temperature would yield a change in adhesive properties.

Similarly, a fiber could lengthen upon temperature increase as illustrated in FIG. 10. A longer fiber would have an increased occurrence of clumping and a change in rigidity, yielding a change in adhesive properties.

Another alternative, is to use fibers composed of two different materials with different thermal expansion coefficients such that an increase in temperature causes deflection of the fibers. This would change the fiber orientation, change the likelihood of clumping, and could cause detachment.

For reversible transitions, shape memory polymers provide an ideal mechanism, allowing reversible changes between adhering and non-adhering states. Sokolowski et al discuss shape memory polymers that are polyurethane-based and that exhibit large reversible change in elastic modulus (up to 500 fold) with change in temperature above/below the glass transition [92]. Such a material allows repeated shape changes. It is easily deformed in a rubbery state that can be frozen in place. The material can then be heated again to achieve its original state, which can be made rigid by subsequent cooling.

The use of a shape memory polymer in a fibrillar adhesive provides another avenue for an adhesive with differing adhering states. The adhesives could be stored in a non-adhesive state (e.g., collapsed fibers), which could be activated by heating the materials and allowing it to cool into a rigid fiber state.

For medical applications, biodegradable shape memory polymers have been developed. Lendlein et al describe such a polymer that can be deformed up to 400% between its temporary and permanent states [65]. The polymer is made of two components with different thermal properties. Lendlein et al demonstrated a suture that can be tightened after sewing. The temperature is increased to 50° C. and the fiber is stretched to three times its length and then cooled to lock it into its temporary state. The fiber was then used to loosely stitch a rat wound. The temperature was then increased to 41° C. to tighten the fiber (return it to its permanent state). The biodegradable fiber is later dissolved. Lendlein et al also demonstrated a corkscrew shape typical of stent using the material.

For the purposes of a fibrillar adhesive, the use of a polymer such as the one described by Lendlein et al (or those with similar properties) enables transitions in adhesive states. Fibers such as those illustrated in FIG. 8 could be heated and stretched and then allowed to cool. The elongated fibers could act like those in FIG. 10 and partially fall over to induce more clumping and to cause more side contact. Further elongated fibers could yield a more completely collapsed fiber structure such as that seen in FIG. 4. This temporary elongated state would be a non-adhering or reduced adhering mode. Application of heat would allow the fibers to shrink back to their permanent state to generate. Upon subsequent cooling, the fibers would be fixed in an adhering mode. Application of heat and stretching could then reverse the process. Fibers could potentially be stretched by adhering to a surface and pulling away, then cooling. They could also be flattened towards the surface and then cooled, to lock them into a temporary collapsed state. Or, the fibers could be locked into a variety of other temporary shapes such as those described above (bunched, partial bunched) and others.

An adhesive with fibers composed of shape-memory polymers could be kept in a non-adhering mode for storage. When adhering is desired, an increase in temperature could be used to activate adhesion.

The above have described temperature change influences focusing on the fibers. A similar effect could be employed by varying the backing materials so that they are influenced by temperature change. One key factor that can be changed is compliance.

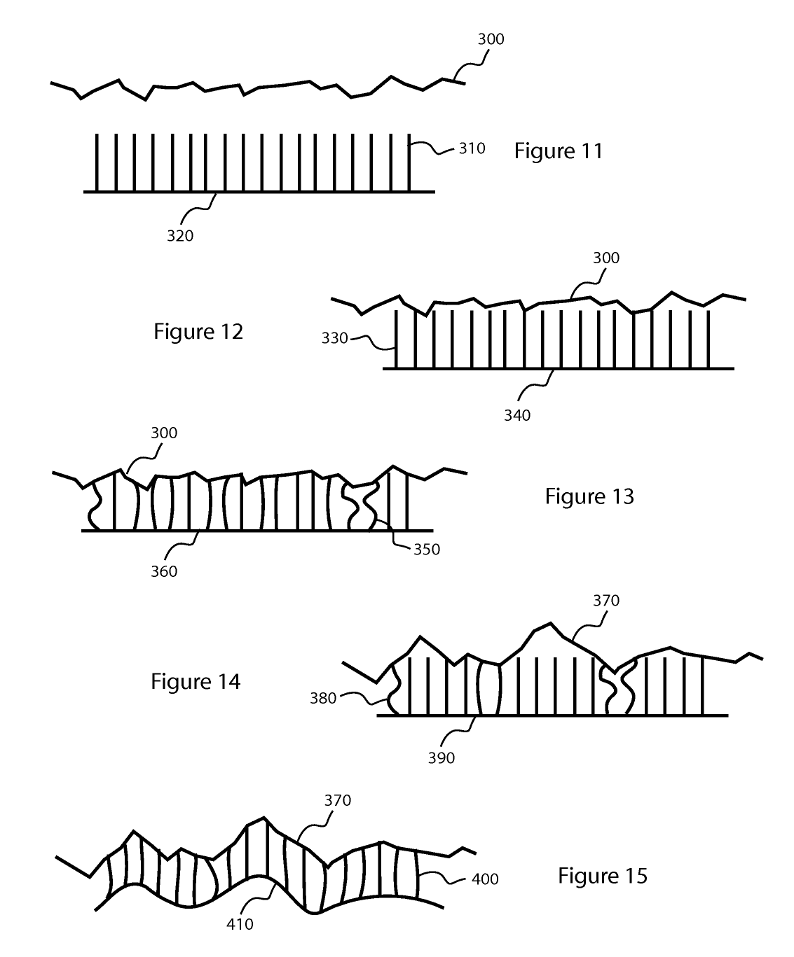

FIG. 11 illustrates fibers 310 on a backing 320 adjacent to a rough surface 300. If both the fibers 330 and backing 340 are non-compliant, the effect seen in FIG. 12 is produced. The fibers 330 contact the rough surface 300 at a limited number of points and the remaining fibers are prevented from contacting the surface.

If the fibers are made compliant as in FIG. 13 (for example, by increasing the temperature), the fibers 350 conform to the rough surface 300 allowing additional points of contact and increased adhesion. If a very rough surface 370 is approached as in FIG. 14, compliant fibers 380 alone may not suffice if the backing 390 is rigid. As seen in FIG. 14, many of the fibers are still not able to contact the surface and adhesion is reduced. This can be addressed by changing the backing to compliant (for example, by increasing the temperature). As seen in FIG. 15, with both compliant fibers 400 and a compliant backing 410 the fibers are able to contact even a very rough surface.

Thermal changes may be used to influence the rigidity of both fibers and backing to cause a change in the adhesive properties. While only two levels of compliance have been described, the same concept could be extended to additional levels of compliance so the effect is seen on three or more levels. By turning on and off (or varying the level of) compliance in either the fibers, backing, or both, the adhesive properties may be varied.

### Electric

Lahann et al describe a reversibly switching surface capable of changing between a hydrophilic and hydrophobic state upon application of an electric potential [63]. A low density, self-assembled monolayer (dimensions are molecular scale, 1-2 orders of magnitude smaller than gecko fibers) with a hydrophilic head on a hydrophilic chain is used. When the head is extended, the surface is hydrophilic, when it is not the surface is hydrophobic. This transition occurs by using an electric potential so that the negatively charged head is attracted to surface, exposing the hydrophobic chain.

The Lahann et al concept may be extended to fibrillar adhesives. Fibers with a charged tip can be attracted to the backing upon application of an electric field. This will result in a change in the exposed portion of the fiber (a transition from FIG. 3 to FIG. 4), modifying the shape of the contact point, the orientation of the fiber, and could also cause a transition from hydrophobic to hydrophilic. The adhesive properties could therefore be tuned upon application of an electric field. If different types of fibers are used, an increasing field could lead to an increasing change in adhesive properties (for example, only some fibers move initially, then others. An attached adhesive could also be detached by application of an electric field that causes the fibers to be attracted to the backing and away from the adhered to surface.

Kirupenkin et al developed an electrically tunable superhydrophobic nanostructured surface [61]. In their structure there is no fiber movement but they provide dynamic electrical control of wetting, reversibly switching between rolling ball and hydrophilic surfaces. This is another alternative for tuning fibrillar adhesive structures, one where fiber movement is not required but surface characteristics and therefore adhesive strength can still be changed.

Bar Cohen describes a variety of electroactive polymers (EAPs) [12, 13]. Materials such as these are well suited for dynamically tunable fibrillar adhesives. EAPs can be activated through a variety of means, such as chemical, thermal, pneumatic, optical, and magnetic.

Bar Cohen provides a list of leading EAP materials in two main categories—electronic and ionic.

Electronic EAPs, or those driven by an electric field, include: [12, 13]
Dielectric EAP,
Electrostrictive Graft Elastomers,
Electrostrictive Paper, and
Electro-Viscoelastic Elastomers
Ferroelectric Polymers.

Ionic EAPs, or those involving mobility or diffusion of ions, include:
Carbon Nanotubes
Conductive Polymers
ElectroRheological Fluids
Ionic Polymer Gels, and
Ionic Polymer Metallic Composite.

Bar Cohen compares the differences between these two categories of EAPs [12, 13]. Electronic EAPs (electrostrictive, electrostatic, piezoelectric, and ferroelectric) are driven by an electric field and can hold a displaced position under dc voltage. However, they tend to require high voltages.

Ionic EAPs (gels, polymer-metal composites, conductive polymers, and carbon nanotubes), on the other hand, are driven by the diffusion of ions and require an electrolyte to function. This can happen at low voltages but they generally must be maintained wet. Conductive polymers and carbon nanotubes can maintain a dc displacement but other have difficulty.

The displacement of both EAP types can be geometrically designed to bend, stretch, or contract. A significant curve response is possible enabling actuators with good response, but with limited torque produced. Fortunately, for purposes of a fibrillar adhesive, each fiber does not require significant torque.

Harrison describes in additional detail piezoelectric polymers, which can deform under application of electrical charge or signal [44]. Piezoelectric polymers can be easily processed and formed into complex shapes. The piezoelectric effect is found in a variety of materials, including ceramics, polymers, and biological systems (collagen, polypeptides, DNA, chitin). One important piezoelectric polymer is keratin, which, as the gecko's choice of materials for its toe pad, may be uniquely suited for tunable fibrillar adhesives.

A number of groups have demonstrated piezoelectric nanotubes and nano fibers, such as Majumdar et al [74].

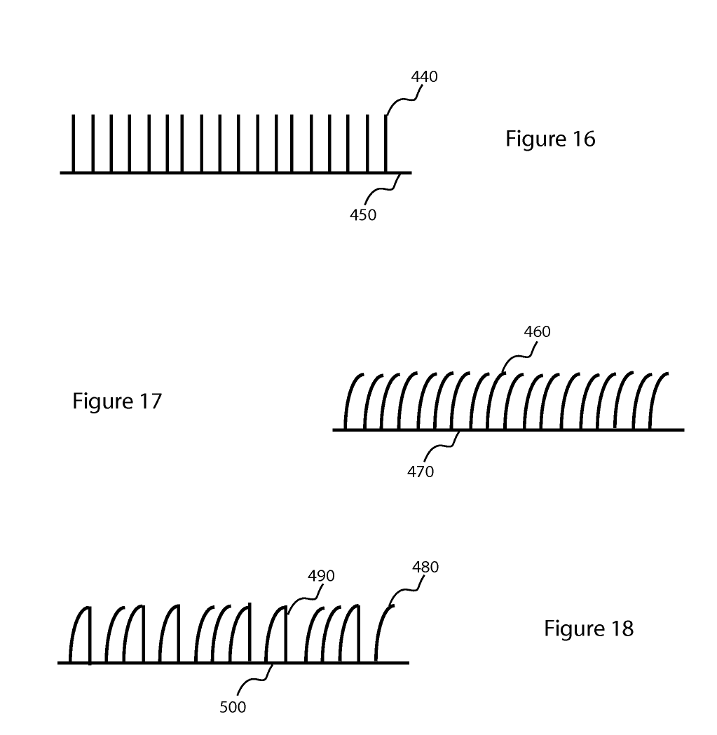

EAPs, piezoelectric polymers, and piezoelectric nanowires and nanotubes used in combination with fibrillar adhesives can provide a dynamically tunable adhesive as well as facilitate attachment and detachment. For example, the erect fibers 440 of FIG. 16 attached to backing 450 can be deflected upon application of an electric field or potential. If all fibers are deflected in the same direction, the result seen in FIG. 17 occurs where fibers 460 are deflected. Such a deflection changes the fiber orientation and may change the fiber contact area resulting in a change in adhesive characteristics. If not all of the fibers are deflected in the same direction, clumping can be induced. If some fibers deflect and some do not, the result depicted in FIG. 17 occurs where some fibers deflect (eg 480) and some do not (eg 490). The non deflected and deflected fibers can then cluster together.

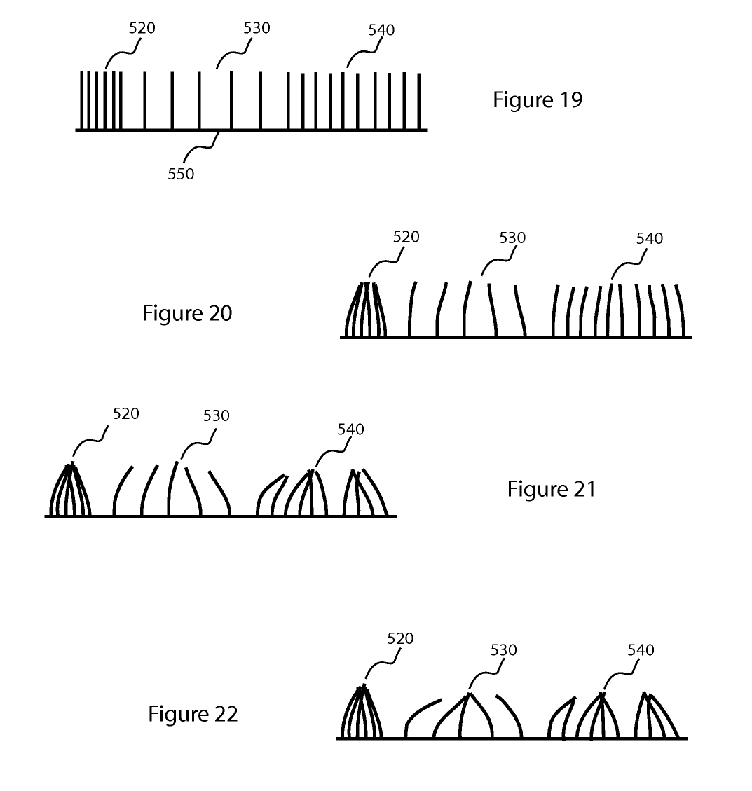

By using fibers that are unequally spaced, clumping can gradually increase as the electric field increases. FIG. 19 illustrates a fibrillar adhesive with fibers of three different densities, high 520, medium 540, and low 530. Applying an electric field will deflect the fibers. As illustrated in FIG. 20, first the high density fibers 520 clump. Upon increase in field and deflection, clumping occurs in both the high 520 and medium 540 density fiber as can be seen in FIG. 21. Upon yet further increase in field and deflection, clumping is seen at all three densities, high 520, medium 540, and low 530, as seen in FIG. 22. Such a design enables the adhesive properties of a fibrillar adhesive to gradually be changed.

Deflecting the fibers by application of an electric field can also be used to cause detachment. Fibers can be caused to cluster to each other rather than a surface. Deflection can also pull fibers off of a surface individually so that a macroscopic peel off is not necessary.

The application of an electric field can also be used to change the shape of the backing and in that way affect the adhesive properties.

An electric field can also be used to induce a dipole. A dipole in the fibers can induce a dipole in the surface to which they are adhering, yielding an increase in VDW forces and therefore adhesion. By varying the strength of the dipole in the fiber, the adhesive properties can be varied. Varying the polarizability would have a similar effect.

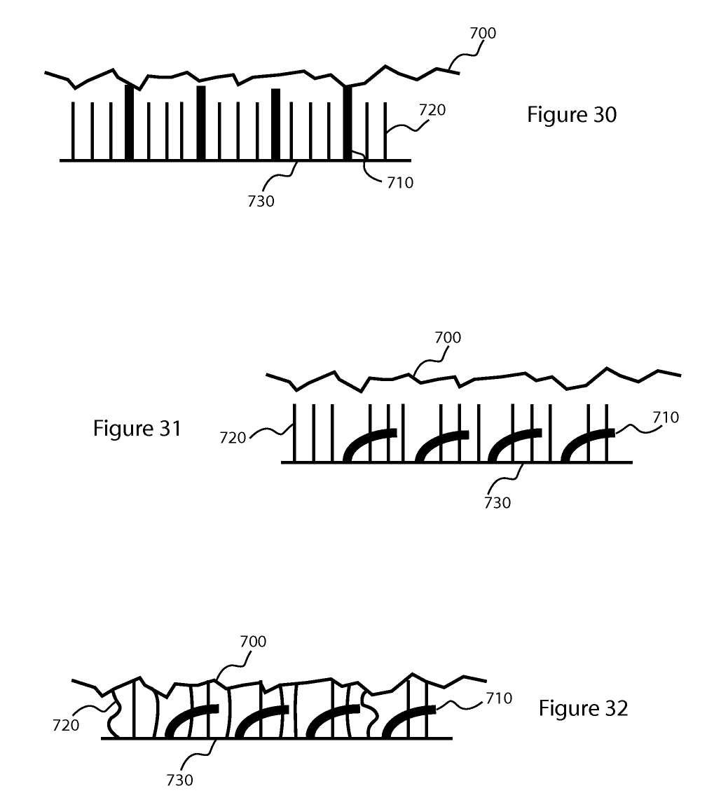

Another alternative approach is depicted in FIGS. 30-32. FIG. 30 depicts a fibrillar adhesive with two types of fibers. Regular compliant fibers 720 are intermixed in an array with taller rigid fibers 710. When the adhesive is pushed against a rough surface 700, the rigid fibers 710 contact but prevent contact of the more numerous regular fibers 720. Applying an electric field can deflect the tall rigid fibers 710 as illustrated in FIG. 31. Pushing the adhesives into the surface 700 allows the regular fibers 720 to contact the surface and generate an adhesive effect, as illustrated in FIG. 32. Removal of the electric field would cause the rigid fibers to extend and facilitate detachment. (Note—the rigid fibers could also be at the same height as the regular fibers).

Growth or manufacture of fibers under an electric field can lead to anisotropy that can later be influenced by an external field.

### Magnetic

Materials that deform under a magnetic field have been developed by Varga et al [103]. Small nano/micro magnetic particles are incorporated into a highly elastic polymer matrix. When a magnetic field is applied shape distortion occurs instantly and leaves quickly when the field is removed. The materials exhibited large deformations, tunable elastic modulus, non-homogeneous deformation, and fast response. Varga et al prepared the elastic materials under an external field to lead to anisotropy, which results in direction dependent elastic modulus and also direction dependent swelling. Varga et al indicate that the preparation of magnetic field sensitive gels and elastomers does not require a special polymer or magnetic particle. The material can be made of any flexible macromolecule that can be cross-linked combined with a ferri or ferromagnetic material. Varga et al suggests the polymer should have a low elastic modulus to allow for significant shape distortion. For the purposes of a fibrillar adhesive, however, a higher elastic modulus is generally desirable.

Zrinyi et al have developed a ferrogel that is controllable by a magnetic field [111]. Elongation, contraction, and bending can be realized by proper arrangement of the external field.

The various effects described in the Electric section above can also be extended to fibers influenced by a magnetic field. The polymers used could include nano sized magnetic particles embedded within, like those of Varga et al.

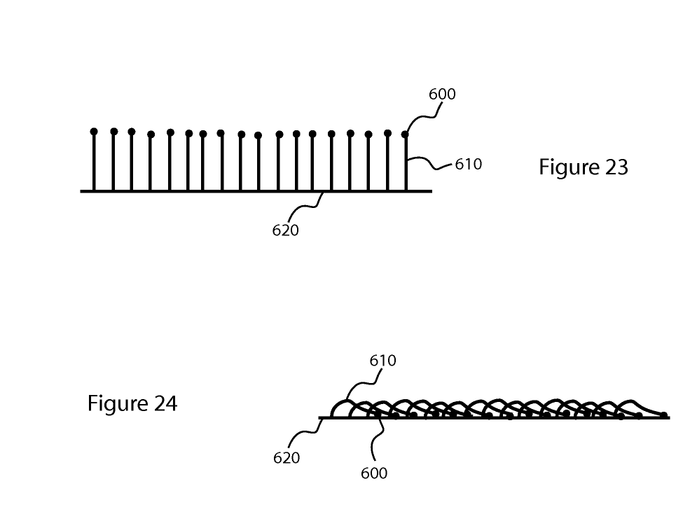

Alternatively, a magnetic functional group could be placed at the fiber tip (or elsewhere). FIG. 23 illustrates fibers 610 with a functional tip 600, on backing 620. If the functional tip 600 is magnetic, it can be drawn to the backing 620, pulling the fiber 610 towards the backing, when the backing is magnetized. This will impact the adhesive properties as described earlier.

### Photonic

Juodkazis et al demonstrate reversible phase transitions in polymer gels induced by radiation forces [59]. A laser beam is used to induce reversible shrinkage in a polymer gel. Shrinkage occurs up to tens of μm away from where the beam hits. Rod-shaped microgels were prepared by polymerizing in a glass capillary tube. The force of the laser beam causes gel collapse.

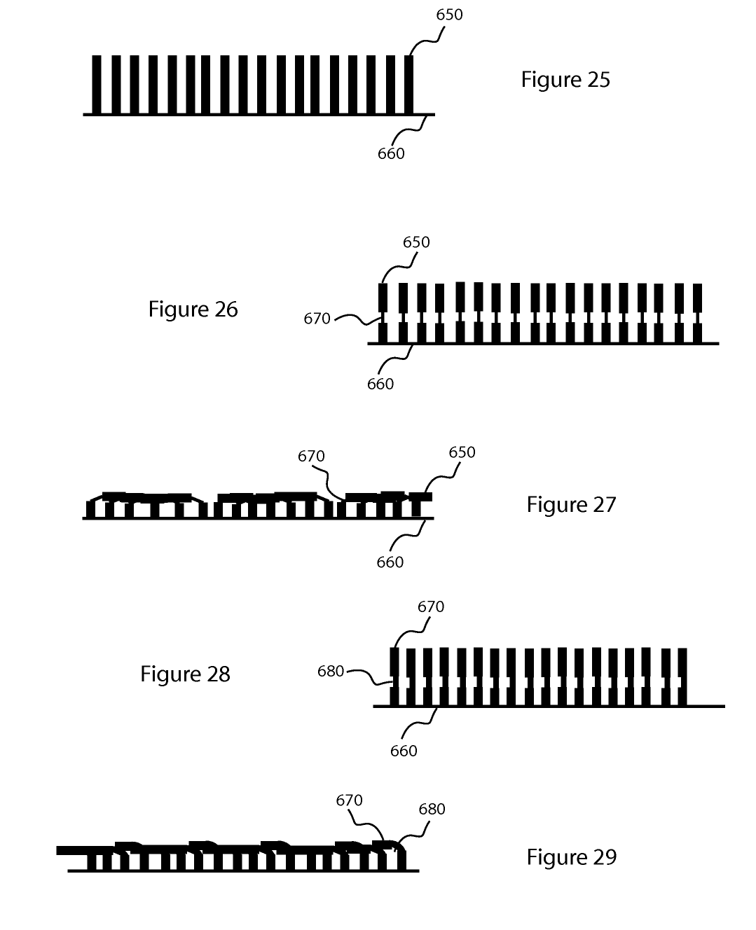

The polymer of Juodkazis et al is particularly applicable to solution based fibrillar adhesives, but a similar affect could be applied in non solution systems. Shrinkage could induce fibers to fall over and clump or bind to backing. For example, the fibers 650 of FIG. 25, which are attached to backing 660, could, upon application of a laser or other focused light source, cause localized collapse of the fibers as illustrated in FIG. 26. A section of fiber 670 shrinks cause the fiber to fall over as illustrated in FIG. 27. This will impact the adhesive properties of the material by changing such factors as the portion of fiber that would contact a surface and extent of clumping.

By inducing shrinkage on only one side 690 of a fiber as illustrated in FIG. 28, the fibers can be caused to collapse all in one direction.

Jiang et al also describe shape memory polymers triggered by application of light.⁵⁶ The polymers can be locked into complicated shapes by application of UV light. Application of UV of a different wavelength causes a return to the original shape.

Chemical/Solution properties

Various materials have been demonstrated which deform under changing solution conditions or chemical activation (such as changing pH or salt/solvent concentrations). Shreyer et al discuss artificial muscles activated chemically [89]. Chemically activated fibers exhibited significant length changes under the influence of acids/bases. Electrical activation (electrolysis of water) was also used to induce a localized pH reduction significantly altering fiber length.

Application of such an effect to a fibrillar adhesive yields an associated change in adhesive properties as discussed regarding FIG. 10 in the thermal section.

Wang et al use a redox reaction to cause a conformational change [105]. A gold electrode is coated with a monolayer of bipyridinium units tethered to it by long thiol chains. A redox reaction causes a conformational change that causes the hydrophobic chain to be exposed, changing the surface from hydrophilic to hydrophobic.

Application of such an effect to a fibrillar adhesive yields an associated change in adhesive properties as discussed in the electric section.

### Mechanical

Fibers could also be mechanically displaced to yield a change in adhesive properties and to facilitate attachment and detachment as described in the previous sections.

### Functionalized Fibers

Magnetic functionalized tips were discussed above in the Magnetic section. In addition, as summarized above, the Dubrow patent application details the option of having fibers that are coated or functionalized to enhance an existing property or to add new properties [25].

The adhesive strength might be increased by imposing a dipole or charge on the tip (or inducing that charge). This charge could be permanent (based on the molecular structure of the tip or fiber) or could be applied at desired times (for example, through the fiber or shaft portion). Such a charge could induce dipoles on the contacted surface and facilitate a stronger bond. Altering the polarity of the charge could facilitate detachment and charge based repulsion could potentially be generated.

Functionalized fibers can be combined with the influencers above to yield additional effects. For example, functionalized tips could be extended or withdrawn upon application of an electric field to change adhesive or other properties. It should be noted that not all fibers need to be functionalized to yield an effect and different functionality can be given to different fibers.

### Hook and Loop, and Interlocking Fasteners

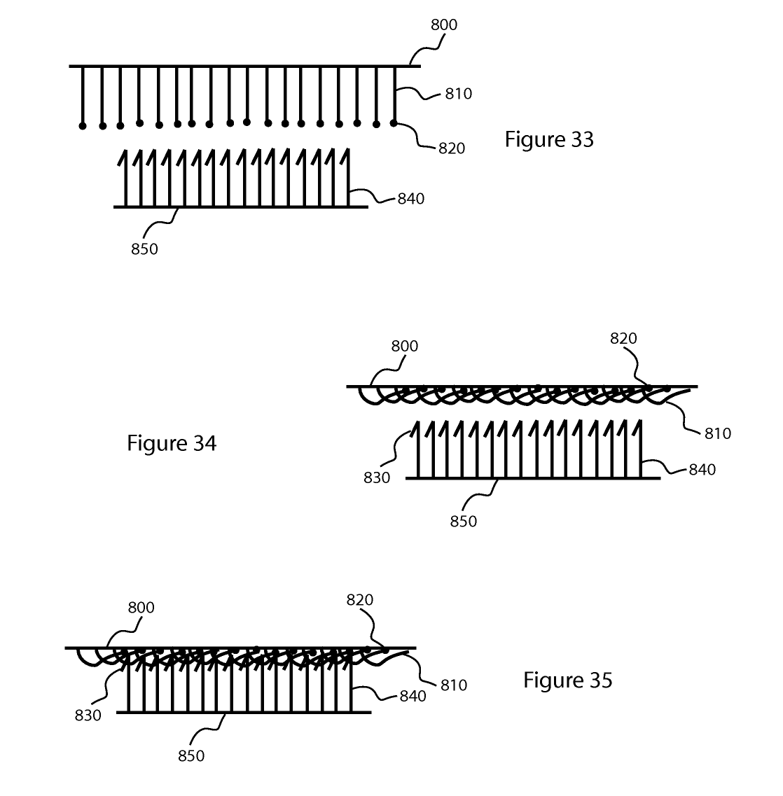

The effect described above of attracting a fiber tip to a surface can be extended to turn on and off hook and loop fasteners. FIGS. 33-35 illustrate such a fastener in on and off modes. FIG. 33 illustrates an off mode where fibers 810 with functionalized tip 820 are extended and do not form a loop. An adjacent hook 830 attached to a fiber 840 will not adhere. In FIG. 34, the functionalized tip 820 has been activated to draw it to the backing/substrate 800 forming a loop. In FIG. 35, the hook and loop are combined to yield an interlocked structure and adherence.

A similar effect can also be applied to various other interlocking systems, such as those described by Larsson et al, Han et al, Berber et al, and Reed et al [81, 82, 42, 14, 43, 64]. Use of materials that enable deflection of the various extended portions, or straightening of hooks, can enable controllable release. For example, the “Micromechanical Velcro” of Han et al could be designed to include collapsible wings that are pulled to the pillars in the same fashion that fibers are pulled to their backing [43].

Such systems are applicable on a variety of length scales, including a larger scale.

### USES/EXAMPLES

The mechanisms described for dynamically changing the adhesive properties and facilitating attachment and detachment are exemplary and not intended to limit the invention to only those shown here. The general concept of dynamically tuning fibrillar adhesive properties as well as facilitating attachment and detachment has been described as have a variety of embodiments. The examples described in the various categories (thermal, electric, etc) can be extended to other categories and the various influencers can be used in different combinations to yield more complex effects and controls. The examples described tended to focus on length scales comparable to gecko fibers but can also apply to larger and smaller length scales.

Note that the figures have depicted a side view of the fiber arrays, which are three dimensional.

The mechanisms described for dynamically changing the adhesive properties and facilitating attachment and detachment can be used for a variety of different categories of adhesives including, but not limited to:
Single change adhesives, where the change in adhesive properties occurs only once,
Multiple change adhesives, where the adhesive properties can change between different states multiple times,
On/off adhesives, where the adhesive properties can be changed between two states,
Dynamically tunable adhesives, where the adhesive properties can be changed across multiple (two or more) different states,
No peel adhesives, where peeling is not required to facilitate detachment,
Remotely activatable, deactivatable and dynamically tunable adhesives
Double-sided adhesives, with adhesive material on both sides (each side can be tunable independently).

The invention and associated mechanisms described for dynamically changing the adhesive properties and facilitating attachment and detachment can be used for a variety of different applications including, but not limited to:
Medical
Military
Consumer
Industrial

### Medical

As described by Dubrow [25], fibrillar adhesives can be used for devices including clamps (e.g., c-clamps, barrel clamps, circular clamps, etc.), stents, shunts, probes, retractors, patches and/or bandages, laminar sheets (e.g., bandages, patches, laminar strips, etc.), medical meshes, screws, nails, etc. The adhesives can be used to enhance gripping, prevent sliding, fix devices in place, etc when desired. When motion or varied adhesive strength is desired, an influencer such as described can be activated to change the adhesive properties.

For example, a medical camera could enter the body and be fixed in a given location for viewing purposes by activating the adhesive. The adhesive can be deactivated, the camera moved to a new location, and the adhesive reactivated, to view in a new location. The speed of the camera's motion could be controlled by adjusting low level adhesion forces (higher=slower).

A variety of different bandage types could be made using the present invention. A no-pain bandage could be made where adhesion is turned off to ensure no pain upon bandage removal. A bandage that pulls a wound closed can also be made by using a backing that shrinks upon application of heat. Such a bandage could have two adhesive sides that are placed on opposite sides of the wound and drawn together upon application of heat (for example using a shape memory polymer backing).

Drug release could be controlled by turning off adhesion and releasing attached materials in different quantities.

Adhesive tipped tools could be used to delicately move and hold biological components in place during surgery and the like. Once the needed steps are complete, the adhesive can be turned off and the tool removed without damage to the tissue, etc.

The medical applications are numerous and are provided as example only and should not be construed to limit the invention.

### Military

The adhesives could be used for climbing equipment as well for hanging. Dubrow indicates that ‘The ability of the invention to be incorporated into flexible forms allows the rocking or peeling away of the nanofibers from the surface to which they are adhered. The rocking/peeling changes the contact angle of individual nanofibers in relation to the surface they are adhered to and, thus, can cause release of the individual fiber.” [25]. As can be envisioned, there are some applications where flexible forms, or the required peeling motion, are not possible and the present invention enables attachment and detachment in such circumstances.

Gloved hands, for example, may not always wish to move in a peeling fashion. The present invention allows adherence when desired that can then be turned off, for example, so a hand can be moved and then repositioned with adhesive reactivated. Gloves with tunable adhesion could also be useful when gripping strength changes are desired.

Robots with tunable adhesive feet would be desirable—adhesion could be maximized while climbing a vertical surface and minimized when on a horizontal one (to allow maximum speed). The foot motion would not need to be the complex peeling motion of the gecko, since adhesion can be turned on and off.

Remotely deactivatable adhesion could be used to remotely detach devices or objects. For example, a wireless (or wired) receiver could receive a signal from a remote location. That signal could activate an electric or magnetic field which deflects the adhesive fibers and causes detachment of whatever was held by the adhesive.

### Consumer

A variety of consumer applications can be envisioned: Wall paper that can be easily removed by deactivating adhesion, for example, by application of a magnetic field; Wall hangers that can be removed without damage to the underlying wall surface; sealable and resealable envelopes and containers.

### Industrial

The adhesives could be used for climbing, hanging, and gripping equipment as well as the applications described in the earlier sections.

Materials or devices could be fixed into place with the adhesive and released when desired. For example a screw could be fixed when screwed in and then, when removal is desired, the adhesive could be deactivated.

The uses described in the different categories (medical, military, etc) also apply to different categories. In addition, the properties of the invention can be used for purposes other than adhesion. For example, the friction or drag force caused by a surface can be dynamically altered by modifying the surface as described. For example, friction or drag can be increased by extending the fibers and reduced by deflecting them.

The adhesives may be made with fibers, pillars, tubes, whiskers, rods, protrusions and the like in the various ways described and unless explicitly noted, these terms may be used interchangeably.

### REFERENCES

1. Agheli, H. and Sutherland D. S. “Nanofabrication of Polymer Surfaces Utilizing Colloidal Lithography and Ion Etching” IEEE Trans. NanoBiosc., 5:9-14 (2006)
2. Anand, J. and Jinsoo, K. “Fibrillar microstructure and processes for the production thereof” US Patent Publication 20050181629 (2005)
3. Aristotle, “The History of Animals” http://classics.mit.edu/Aristotle/history_anim.9.ix.html, Translated by D′Arcy Wentworth Thompson (350 B.C.E)
4. Arzt, E. et al “From micro to nano contacts in biological attachment devices” PNAS, 100:10603-10606 (2003)
5. Arzt, E. et al “Methods for modifying the surfaces of a solid and microstructured surfaces with encreased adherence produced with said methods” US Patent Publication 20060005362 (2006)
6. Autumn, K “Adhesive microstructure and method of forming same” US Patent Publication 20030124312 (2003)
7. Autumn, K. and Hansen, W. R. “Self-cleaning adhesive structure and methods” US Patent Publication 20050151385 (2005)
8. Autumn, K. and Peattie, A, “Mechanisms of Adhesion in Geckos” Itegr. Comp. Biol, 42: 1081-1090 (2002)
9. Autumn, K. et al “Dynamics of geckos running vertically” J. Exp. Bio., 209:260-272 (2006)
10. Autumn, K., et al, “Adhesive force of a single gecko foot-hair” Nature, 405:681-684 (2000)
11. Autumn, K., et al, “Evidence for van der Waals adhesion in gecko setae” PNAS (2002)
12. Bar-Cohen, Y. “Electroactive Polymers as Artificail Muscles—Reality and Challenges” Amer. Inst. Aero. Astro., Paper #2001-1492 (2001)
13. Bar-Cohen, Y., “Electrochemistry Encyclopedia” Website http://electrochem.cwru.edu/ed/encycl/art-p02-elact-pol.htm
14. Berber, S. et al “Bonding and Energy Dissipation in a Nanohook Assembly” Phys. Rev. Lett., 91:165503-1-165503-4 (2003)
15. Bergmann, P. And Irschick, D., “Effects of Temperature on Maximum Clinging Ability in a Diurnal Gecko: Evidence for a Passive Clinging Mechanism?” J. Exp. Zoo., 303A:785-791 (2005)
16. Blackwall, J. “On the means by which walk various animals on the vertical surface of polished bodies” Ann. Nat. Hist., XV:115 (1845) from 8
17. Bloch, N. and Irschick, D. J. “Toe-clipping dramatically reduces clinging performance in a pad-bearing lizard (Anolis carolinensis)” J. Herp., 37:293-298 (2004)
18. Chaudhury, M. K. et al “Adhesive contact of a cylindrical lens and a flat sheet” J. Appl. Phys., 80:30-37 (1996)
19. Chen, S. and Gao, H. “Non-slipping adhesive contact of an elestic cylinder on stretched substrates” Proc. Roy. Soc. A, 462:211-228 (2005)
20. Crevoisier, G. et al “Switchable Tackiness and Wettability of a Liquid Crystalline Polymer” Science, 285:1246-1249 (1999)
21. Crosby, J. A. et al “Controlled Polymer Adhesion with ‘Pancakes’” Langmuir, 21:11738-11743 (2005)
22. Dai, Z. et al “Adhesion Characteristics of Polyurethane for Bionic Hairy Foot” J. Intell. Mat. Sys. Struct. (2006)
23. Dellit, W., “Zur anatomic und physiologic der Geckozehe” Jena. Z. Naturw., 68:613-656 (1934) from 8, 83
24. Dubrow, R. “Structures, systems and methods for joining articles and materials and uses therefor” US Patent Publication 20040206448 (2004)
25. Dubrow, R. “Structures, systems and methods for joining articles and materials and uses therefor” US Patent Publication 20040250950 (2004)
26. Fearing, R. S. and Autumn, Kellar “Controlling peel strength of micron-scale structures” US Patent Publication 20060078725 (2006)
27. Fearing, R. S. and Sitti, M. et al “Adhesive microstructure and method of forming same” US Patent Publication 20050181170 (2005)
28. French, R. H. et al “Method for providing nano-structures of uniform length” US Patent Publication 20040038556 (2004)
29. French, R. H. et al “Method for providing nano-structures of uniform length” US Patent Publication 20050079666 (2005)
30. French, R. H. et al “Method for providing nano-structures of uniform length” US Patent Publication 20060014084 (2006)
31. Full, R. J. et al “Adhesive microstructure and method of forming same” US Patent Publication 20050072509 (2005)
32. Full, R. J. et al “Adhesive microstructure and method of forming same” U.S. Pat. No. 6,737,160 (2004)
33. Full, R. J. et al “Adhesive microstructure and method of forming same” U.S. Pat. No. 6,872,439 (2005)
34. Full, R. J. et al “Adhesive microstructure and method of forming same” U.S. Pat. No. 7,011,723 (2005)
35. Gao, H. And Yao, H. “Shape insensitive optimal adhesion of nanoscale fibrillar structures” PNAS, 101:7851-7856 (2004)
36. Gao, H. et al “Mechanics of heirarchical adhesion structures of geckos” Mech. Mat., 37:275-285 (2004)
37. Gao, H., et al “Flaw tolerant bulk and surface nanostructures of biological systems” MCB, 1:37-52 (2004)
38. Geim, A. K., et al “Microfabricated adhesive mimicking gecko foot-hair” Nature Mat., 2:461-463 (2003)
39. Glassmaker, N. J., et al “Adhesion enhancement in a biomimetic fibrillar interface” Acta Biomat. 1:367-375 (2005)
40. Glassmaker, N. J., et al “Design of biomimetic fibrillar interfaces: 1. Making contact” J. R. Soc. Interface, 1:23-33 (2004)
41. Haase, A., “Untersuchungen uber den Bau und die Entwicklung der Haflappen bei den Geckotiden” Archiv. F. Naturgesh., 66:321-345 (1900) from 8
42. Han, H. et al “Mating and Piercing Micromechanical Structures for Surface Bonding Applications” IEEE Proceedings of the 1991 Micro Electro Mechanical Systems, An Investigation of Micro Structures, Sensors, Actuators, Machines and Robots, 253-258 (1991)
43. Han, H. et al “Micromechanical Velcro” J. Microelectrom. Syst., 1:37-43 (1992)
44. Harrison, J. S. and Ounaies, Z. “Piezoelectric Polymers” NASA/CR-2001-211422, ICASE Report No. 2001-43 (2001) http://www.teccenter.org/electroactive_polymers/assets/pdfs/piezo_polymers/icase_piezo.pdf
45. Hiller, U., “Comparative studies on the functional morphology of two gekkonoid lizards” Biol. J. Linn. Soc., 62:307-362 (1975) from 8
46. Hora, S., L., “The adhesive apparatus on the toes of certain geckos and tree frogs” J. Proc. Asiat. Soc. Beng., 9:137-145 (1923) from 8
47. Huber, G., et al “Evidence for capillarity contributions to gecko adhesion from single spatula nanomechanical measurements” PNAS 102:16293-16296 (2005)
48. Huber, G., et al., “Resolving the nanoscale adhesion of individual gecko spatulae by atomic force microscopy” Biol. Lett, 1:2-4 (2005)
49. Hui, C.-Y., et al “Design of biomimetic fibrillar interfaces: 2. Mechanics of enhanced adhesion” J. R. Soc. Interface, 1:35-48 (2004)
50. Irschick, D, et al, “A comparative analysis of clinging ability among pad-bearing lizard” Biol. J. Linn. Soc., 59: 21-35 (1996)
51. Israelachvili, J. Intermolecular and surface forces, Academic Press, New York (1992)
52. Jackson, W. B. “Hierarchically-dimensioned-microfiber-based dry adhesive materials” US Patent Publication 20050271869 (2005)
53. Jackson, W. B. “Hierarchically-dimensioned-microfiber-based dry adhesive materials” US Patent Publication 20050271870 (2005)
54. Jagota, A. and Bennison, S. J. “Fibrillar microstructure for conformal contact and adhesion” US Patent Publication 20040076822 (2004)
55. Jagota, A. and Bennison, S. J. “Mechanics of Adhesion Through a Fibrillar Microstructure” Integr. Comp. Biol., 42:1140-1145 (2002)
56. Jiang, H. et al “Polymers Move in Response to Light” Adv. Mat., 18:1471-1475 (2006)
57. Johnson, K. L. et al “Surface Energy and Contact of Elastic Solids” Proc. R. Soc. Lond. A, 324:301-313 (1971)
58. Jones, S. D. And Fearing, R. S. “Apparatus for friction enhancement of curved surfaces” US Patent Publication 20050092414 (2005)
59. Juodkazis et al “Reversible phase transitions in polymer gels induced by radiation forces” Nature, 408:178-181 (2000)
60. Knowles, T. R. and Seaman, C. L. “Fiber adhesive material” US Patent Publication 20040071870 (2004)
61. Krupenkin, T, et al “Electrically Tunable Superhydrophobic Nanostructured Surfaces” Bell Labs Tech. J., 10:161-170 (2005)
62. Lahann, J and Langer, R. “Smart Materials with Dynamically Controllable Surfaces” MRS Bulletin, 30:185-188 (2005)
63. Lahann, J. et al “A reversibly switching surface” Science, 299:371-374 (2003)
64. Larson, M. P. et al “Improved adhesion in hybrid Si-polymer MEMS via micromechanical interlocking” J. Micromech. Microeng., 15:2074-2081 (2005)
65. Lendlein, A. and Langer, R. “Biodegradable, Elastic Shape-Memory Polymers for Potential Biomedical Applications” Science, 296:1673-1676 (2002)
66. Lendlein, et al “Light-induced shape-memory polymers” Nature, 434:879-882 (2005)
67. Leroy, S. et al “Surgical instrument for adhering to tissues” US Patent Publication 20050119640 (2005)
68. Lin, C. et al “Fabrication method of nanoimprint mold core” US Patent Publication 20060110125 (2006)
69. Lindsay, J. D. et al “Activatable fastening system and web having elevated regions and functional material members” US Patent Publication 20050132543 (2005)
70. Lindsay, J. D. et al “Gecko-like fasteners for disposable articles” US Patent Publication 20050148984 (2005)
71. Liu, et al “Controlled Switchable Surface” Chem. Eur. J., 11:2622-2631 (2005)
72. Mahendra, B., “Contributions to the bionomics, anatomy, reproduction and development of the Indian house gecko hemidactylus flaviviridis Ruppell. Part II. The problem of locomotion” Proc. Indian Acad. Sci., Sec. B 13:288-306 (1941) from 8, 83
73. Majidi, C. S. et al “Attachment of fiber array adhesive through side contact” J. Appl. Phys., 98:103521 (2005)
74. Majumdar, A. et al “Method of manufacturing nanostructures and nanowires and devices fabricated therefrom” US Patent Publication 20050161662 (2005)
75. Menon, C. and Sitti, M. “Biologically Inspired Adhesion based Surface Climbing Robots” Intern. Conf. Rob. Autom., Barcelona, Spain (2005)
76. Menon, C. et al “Gecko Inspired Surface Climbung Robots” IEEE Proceedings, Intern. Conf. Rob. Biom. (2004)
77. Mohr, R. et al “Initiation of shape-memory effect by inductive heating of magnetic nanoparticles in thermoplastic polymers” PNAS, 103:3540-3545 (2006)
78. Northern, N. T. and Turner, K. L. “A batch-fabricated biomimetic dry adhesive” Nanotech., 16:1150-1166 (2005)
79. Northern, N. T. and Turner, K. L. “Multi-Scale Compliant Structures for use as a Chip-Scale Dry Adhesive” 13^{th} Int. Conf. Solid State Sensors, Actuators, and Microsystems, Seoul, Korea (2005)
80. Pianka, E and Sweet, S, “Integrative biology of sticky feet in geckos” BioEssays 27:647-652 (2005)
81. Prasad, R. et al “Design, Fabrication, and Characterization of Single Crystal Silicon latching Snap Fasteners for Micro Assembly” Proc. ASME. IMECE (1995)
82. Reed, M. L. et al “Silicon Micro-Velcro” Adv. Mater., 4:48-51 (1992)
83. Ruibal, R. and Ernst, V. “The Structure of the Digital Setae of Lizards” J. Morphol. 117: 271-294 (1965)
84. Schaffer, E. et al “Electrically induced structure formation and pattern transfer” Nature, 403:874-877 (2000)
85. Schleich, H and Kastle, W., “Ultrastrukturen an Gecko-Zehen (Reptilia: Sauria: Gekkonidae” Amphibia-Reptilia, 7: 141-166 (1986) from 8
86. Schmidt, H., “Zur Anatomie und Physiologie der Geckopfote” Jena. Z. Naturw., 39:551 (1904) from 8
87. Selhuber, C. et al “Tuning Surface Energies with Nanopatterned Substrates” Nano Letters, 6:267-270 (2006)
88. Shah, G. J. and Sitti, M. “Modeling and Design of Biomimetic Adhesives Inspired by Gecko Foot-Hairs” IEEE Proceedings, Intern. Conf. Rob. Biom. (2004)
89. Shreyer, H. B., et al “Electrical Activation of Artificial Muscles Containing Polyacrylonitrile Gel Fibers” Biomacrom., 1:642-647 (2000)
90. Sitti, M. “High Aspect Ratio Polymer Micro/Nano Structure Manufactureing using Nanoembossing, Nanomolding and Directed Self-Assembly” IEEE/ASME Adv. Mechatronics Conference, Kobe, Japan (2003)
91. Sitti, M. et al, NanoRobotics Lab Website http://www.me.cmu.edu/faculty1/sitti/nano/projects/geckohair/
92. Sokolowski, W. M., et al “Cold hibernated elastic memory (CHEM) self-deployable structures”
93. Spolenak, R. et al “Effect of contact shape on the scaling of biological attachments” Proc. R. Soc. A, 461:305-319 (2005)
94. Sun, T. et al “Reversible Switching between Superhydrophilicity and Superhydrophobicity” Angew. Chem. Int. Ed., 43:357-360 (2004)
95. Sun, W., et al “The Nature of the Gecko Lizard Adhesive Force” Bioph. J.: Bioph. Lett. (2005)
96. Takei, Y. G., et al “Dynamic Contact Angle Measurement of Temperature-Responsive Surface Properties for Poly(N-isopropylacrylamide) Grafted Surface” Macromolecules, 27:6163-6166 (1994)
97. Tang, T. et al “Can a fibrillar structure be stronger than a non-fibrillar one?” J. R. Soc. Interface, 2:505-516 (2005)
98. Thomas, T. And Crosby, A. J. “Controlling Adhesion with Surface Hole Patterns” J. Adhes., 82:311-329 (2006)
99. UCSB, “AN ON/OFF REVERSIBLE ADHESIVE” UC Case 2006-418, http://research.ucsb.edu/tech_transfer/technologies/2006-418/2006-418.shtml
100. Unver, O. et al “Geckobot and Waalbot: Small-Scale Wall Climbing Robots” (2005)
101. Urry, D. W. et al “Designing for Advanced Materials by the ATt-Mechanism” SPIE, 2716:343-346 (1996)
102. Van Trump, J. E. et al “Fibrillar apparatus and methods for making it” US Patent Publication 20050163997 (2005)
103. Varga, Z. et al “Smart composites with controlled anisotropy” Polymer, 46:7779-7787 (2005)
104. Walsh, R. “Extruded plastic tape” US Patent Publication 20040048103 (2004)
105. Wang, X. et al “Potential-controlled molecular machinery of bipyridinium monolayer-functionalized surfaces: an electrochemical and contact angle analysis” Chem. Comm., 1542-1543 (2003)
106. Yao, U. and Gao, H. “Mechanics of robust and releasable adhesion in biology: Bottom-up designed hierarchical structure of gecko” J. Mech. Phys. Sol., 54:1120-1146 (2006)
107. Yoon, E.-S., et al “Tribological properties of biomimetic nano-patterned polymeric surfaces on silicon wafer” Trib. Lett., 21:31-37 (2006)
108. Yu, M., et al “Structural Analysis of Collapsed, and Twisted and Collapsed, Multiwalled Carbon Nanotubes by Atomic Force Microscopy” Phys. Rev. Lett., 86:87-90 (2001)
109. Yurdumakan, B. et al “Synthetic gecko foot-hairs from multiwalled carbon nanotubes” Chem. Comm., 3799-3801 (2005)
110. Zhao, et al “Interfacial energy and strength of multiwalled-carbon-nanotube-based dry adhesive” J. Vac. Technol. B., 24:331-334 (2006)
111. Zrinyi, M. et al “Ferrogel: a new magneto-controlled elastic medium” Polymer Gels and Networks, 5:415-427 (1997)

I claim:

1. A multi-mode adhesive comprising:
a) a backing material, and
b) a plurality of fibers connected to the backing material,
wherein applying an external influence causes a change in properties of said plurality of fibers such that said multi-mode adhesive changes from a first adhering state with a first adhesive strength to a second adhering state with a second adhesive strength, where said first adhesive strength is different from said second adhesive strength.

2. The multi-mode adhesive of claim 1 where said external influence is thermal.

3. The multi-mode adhesive of claim 1 where said external influence is electric.

4. The multi-mode adhesive of claim 1 where said external influence is magnetic.

5. The multi-mode adhesive of claim 1 where said external influence is chemical.

6. The multi-mode adhesive of claim 1 where said external influence is photonic.

7. The multi-mode adhesive of claim 1 where said external influence is a solution change.

8. The multi-mode adhesive of claim 1 where said external influence is mechanical.

9. The multi-mode adhesive of claim 1 where said change in properties is a change in fiber dimensions.

10. The multi-mode adhesive of claim 1 where said change in properties is a change in fiber shape.

11. The multi-mode adhesive of claim 1 where said change in properties is a change in fiber orientation.

12. The multi-mode adhesive of claim 1 where said change in properties is a change in fiber compliance.

13. The multi-mode adhesive of claim 1 where said change in properties is a change in fiber polarizability.

14. The multi-mode adhesive of claim 1 where said change in properties is a change in fiber surface energy.

15. The multi-mode adhesive of claim 1 where said change in properties is a change in the extent of clumping.

16. The multi-mode adhesive of claim 1 where said plurality of fibers collapse towards the backing material.

17. The multi-mode adhesive of claim 1 further comprising a functional tip at the end of each of said plurality of fibers.

18. The multi-mode adhesive of claim 19 where the functional tip is pulled to the backing material.

19. A multi-mode adhesive comprising:
a) a backing material, and
b) a plurality of fibers connected to the backing material,
wherein applying an external influence causes a change in properties of said backing material such that said dynamically tunable adhesive changes from a first adhering state with a first adhesive strength to a second adhering state with a second adhesive strength, where said first adhesive strength is different from said second adhesive strength.

20. The multi-mode adhesive of claim 21 where said external influence is thermal.

21. The multi-mode adhesive of claim 21 where said external influence is electric.

22. The multi-mode adhesive of claim 21 where said external influence is magnetic.

23. The multi-mode adhesive of claim 21 where said external influence is chemical.

24. The multi-mode adhesive of claim 21 where said external influence is photonic.

25. The multi-mode adhesive of claim 21 where said external influence is a solution change.

26. The multi-mode adhesive of claim 21 where said external influence is mechanical.

27. The multi-mode adhesive of claim 21 where said change in properties is a change in backing material shape.

28. The multi-mode adhesive of claim 21 where said change in properties is a change in backing material compliance.

29. The multi-mode adhesive of claim 21 where said plurality of fibers collapse towards the backing material.

30. The multi-mode adhesive of claim 21 further comprising a functional tip at the end of each of said plurality of fibers.

31. The multi-mode adhesive of claim 32 where the functional tip is pulled to the backing material.
